(19) United States
(12) Patent Application Publication
(10) Pub. No.: US 2012/0160652 A1
(43) Pub. Date: Jun. 28, 2012

(54) KEYBOARD WITH PLATE-TYPE KEYCAP ASSEMBLY

(76) Inventors: Ling-Hsi Chao, Taoyuan (TW); Po-Wei Tsai, Taoyuan (TW); Chih-Chung Yen, Taoyuan (TW)

(21) Appl. No.: 13/337,276

(22) Filed: Dec. 26, 2011

(30) Foreign Application Priority Data
Dec. 27, 2010 (TW) 099225120

(51) Int. Cl. H01H 13/76

(52) U.S. Cl. 200/5 A

(57) ABSTRACT

A plate-type keycap assembly is used in a keyboard. A main body, a keycap, and a connecting part of the keycap assembly are integrated monolithically and form a plate structure with substantially equal thickness. When the main body of the keycap assembly is constrained by a cover and a pedestal part, the keycap in the keyboard is formed as a cantilever structure via the connecting part. The cantilever structure enables the keycap for moving up and down steadily, which no longer needs scissors-type structure in the keyboard. Accordingly, the keyboard may be simplified and miniaturized when utilizing such keycap assembly.

### BACKGROUND OF THE INVENTION

1. Field of the Invention

The invention relates to a keycap assembly and a keyboard, and more particularly, to a plate-type keycap assembly and the keyboard using the same.

2. Description of the Prior Art

Keyboards are necessary for inputting text, symbols, or numbers in the common computer using environment.

A keyswitch in the keyboard according to the prior are usually includes a base, a keycap, and a lifting device connecting between the base and the keycap. In need of steady up and down movement, a scissors-type structure usually used as the lifting device. It is obvious that the scissors-type structure requires multiple connections in the keyswitch, which adds complexity to the manufacturing process and structure of the keyswitch itself. Space taken by the scissors-type structure locating between the base and the keycap also goes against the miniaturization of the keyswitch and the keyboard.

### SUMMARY OF THE INVENTION

Hence, one purpose of the invention is to provide a keycap assembly with simplified structure and a keyboard having such keycap assembly to miniaturize the keyboard.

According to an embodiment of the invention, a keycap assembly is disposed between a cover and a base of a keyboard. The keycap assembly includes a main body and a plurality of keycaps. Each keycap connects to the main body via a connecting part, wherein the main body, the keycaps, and the connecting parts are monolithically integrated as one piece and are a plate structure with substantially equal thickness.

According to another embodiment of the invention, a keyswitch is provided that includes a cover, a keycap assembly, and a base. The keycap assembly is disposed under the cover, the base is disposed under the keycap assembly, and the structure of the keycap assembly is like the aforementioned.

According to another embodiment of the invention, a keyboard is provided that includes a cover, a base disposed under the cover, and a keycap assembly disposed between the cover and the base. The keycap assembly includes a main body and a plurality of keycaps. Each keycap connects to the main body via a connecting part, wherein the main body, the keycaps, and the connecting parts are monolithically integrated as one piece and are a plate structure with substantially equal thickness. The cover has a plurality of openings. Each opening corresponds to one of the keycaps, and each keycap is exposed from the corresponding opening when the keycap assembly is disposed between the cover and the base.

Since the main body, the keycaps, and the connecting parts of the keycap assembly are integrated monolithically and form a plate structure with substantially equal thickness, the keycap in the keyboard is formed as a cantilever structure, which needs no scissors-type structure in the keyboard and is still capable of moving up and down steadily. Accordingly, the keyboard may be simplified and miniaturized when utilizing such keycap assembly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of a keyboard according to a first embodiment of the invention.

FIG. 2 is an illustration of the cross-sectional view of a keyswitch along X-X′ in FIG. 1.

FIG. 3 is an illustration of the exploded view of the keyswitch in FIG. 1.

FIG. 4 is an illustration of the cross-sectional view of a keyswitch according to a second embodiment of the invention.

FIG. 5 is an illustration of the cross-sectional view of a keyswitch according to a third embodiment of the invention.

FIG. 6 is an illustration of the cross-sectional view of a keyswitch according to a fourth embodiment of the invention.

FIG. 7 is an illustration of the cross-sectional view of a keyswitch according to a fifth embodiment of the invention.

### DETAILED DESCRIPTION

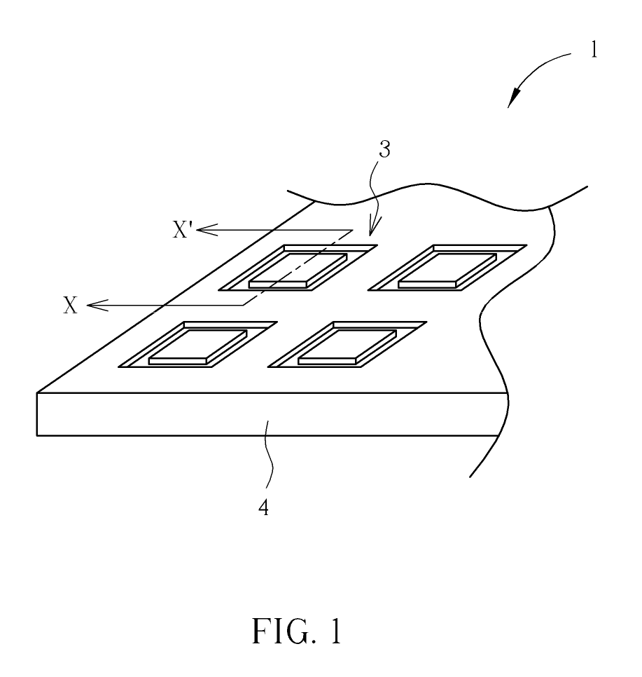

Please refer to FIG. 1. FIG. 1 is an illustration of a keyboard 1 according to a first embodiment of the invention. As shown in FIG. 1, the keyboard 1 includes a plurality of keyswitches 3 and a base 4. Each keyswitch 3 is disposed on the base 4 so that a user can press on any of the keyswitches 3 to perform inputting.

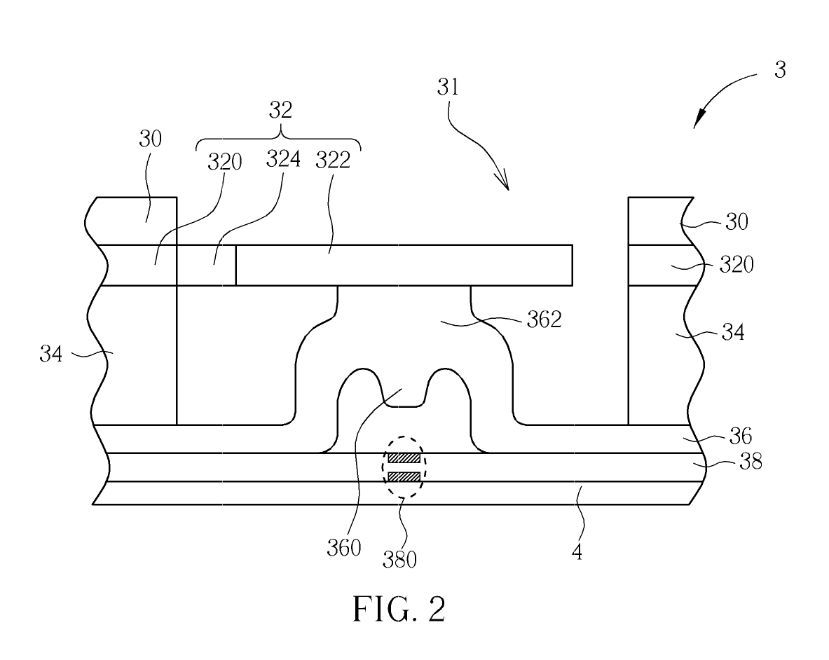

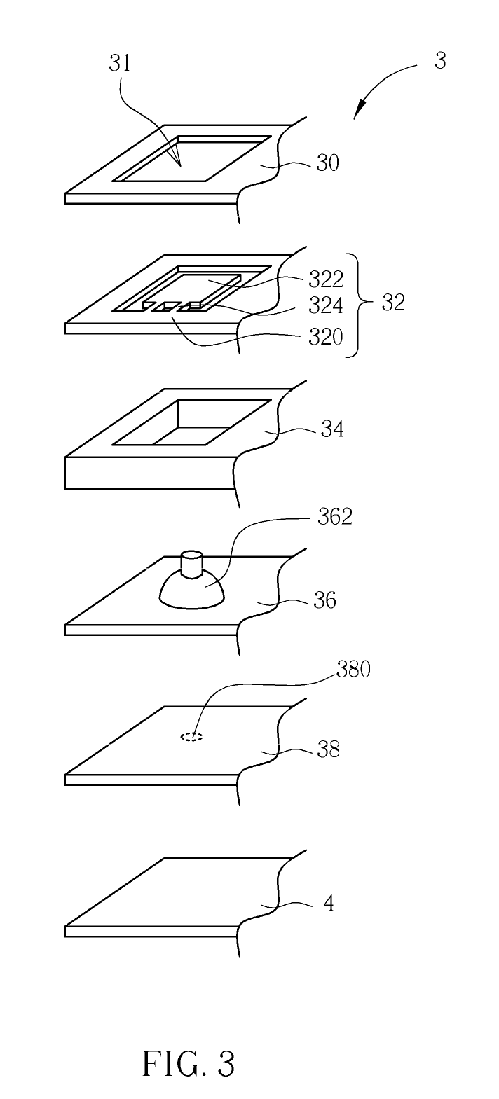

Please refer to FIG. 2 and FIG. 3. FIG. 2 is an illustration of the cross-sectional view of a keyswitch 3 along X-X′ in FIG. 1, and FIG. 3 is an illustration of the exploded view of the keyswitch 3 in FIG. 1. The keyswitch 3 includes a cover 30, a keycap assembly 32, a pedestal part 34, an elastic piece 36, and a circuit board 38. The cover 30 is disposed on the keycap assembly 32 to fix the keycap assembly 32 and prevent dust from coming inside. The pedestal part 34 is disposed under the keycap assembly 32, the elastic piece 36 is disposed under the pedestal part 36, the circuit board 38 is disposed under the elastic piece 36, and the base 4 is disposed under the circuit board 38, where the base 4 can also be part of the keyswitch 3. The keycap assembly 32 includes a main body 320 and a keycap 322. In a more common application, the keycap assembly 32 includes a plurality of keycaps 322 for a functional keyboard. The cover 30 has a plurality of openings 31, each corresponding to one of the keycaps 322 when each keycap 322 is exposed from the corresponding opening 31. The keycap 322 connects to the main body 320 via a connecting part 324. In the embodiment of the invention, the main body 320, the keycap 322, and the connecting part 324 are monolithically integrated as one piece and are a plate structure with substantially equal thickness. Practically, the keycap assembly 32 may be formed by metal stamping. Since the plate structure of the keycap assembly 32 with its main body 320 disposed on the pedestal part 34, the keycap 322 is formed as a cantilever structure via the connecting part 324, capable of moving up and down steadily when pressed by the user.

The elastic piece 36 has a triggering part 360, and the circuit board 38 includes a switch 380, such as a membrane switch or other types of switch, that corresponds to the triggering part 360. The elastic piece 36 may be formed by elastic material or possible resilient material. In this embodiment, a rubber dome 362 is formed on the elastic piece 36, which provides proper recovery force and sense of click toward the keycap 322 when the keycap 322 is pressed downward on the base 4. Also when the keycap 322 is pressed downward, the triggering part 360 of the elastic piece 36 then triggers the switch 380 below.

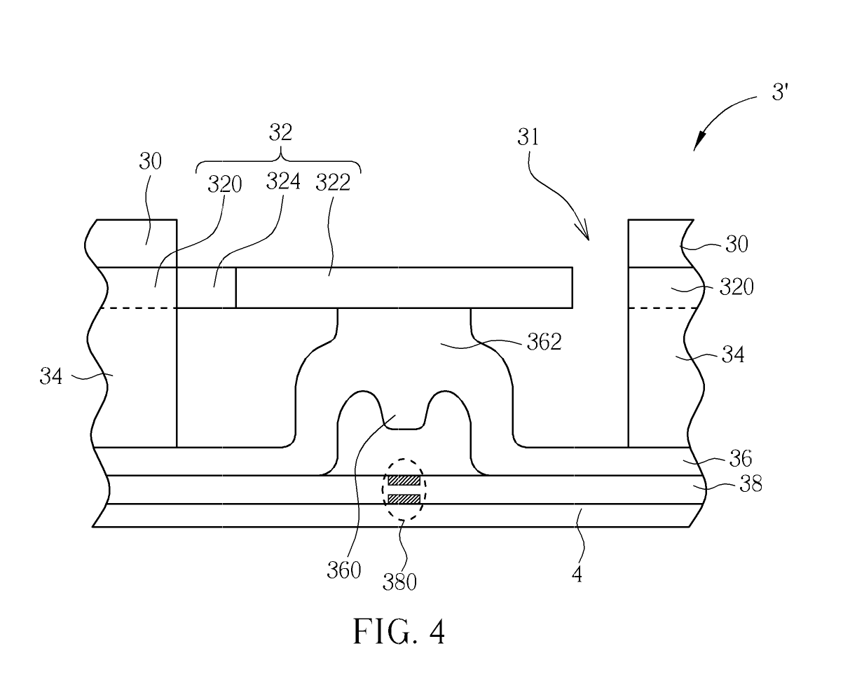

Please refer to FIG. 4, which is an illustration of the cross-sectional view of a keyswitch 3′ according to a second embodiment of the invention. The keyswitch 3′ in the embodiment incorporates the pedestal part 34 with the main body 320, the keycap(s) 322, and the connecting part(s) 324 of the keycap assembly 32 so that these components form a monolithical one piece. The dashed lines between the main body 320 and the pedestal part 34 indicates the monolithical feature. Such monolithical one piece may be easily manufactured when the keycap assembly 32 and the pedestal part 34 are concurrently processed by metal/plastic stamping.

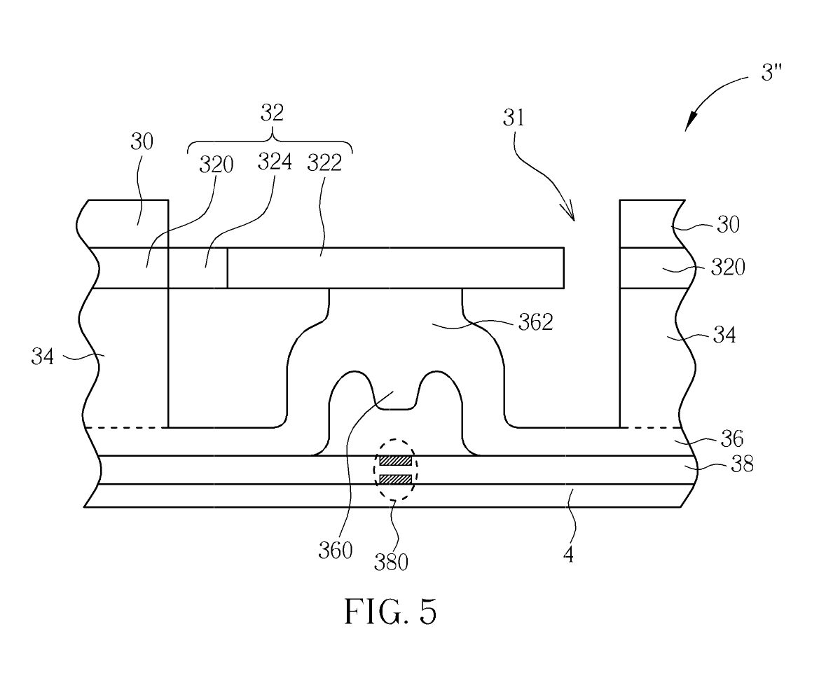

Please refer to FIG. 5, which is an illustration of the cross-sectional view of a keyswitch 3″ according to a third embodiment of the invention. The keyswitch 3″ in the embodiment incorporates the pedestal part 34 with the elastic piece 36 so that these components form a monolithical one piece. The dashed lines between the elastic piece 36 and the pedestal part 34 indicates the monolithical feature. Such monolithical one piece may be easily manufactured when the keycap assembly 32 and the pedestal part 34 are concurrently processed by plastic stamping given the material characteristic of the elastic piece 36.

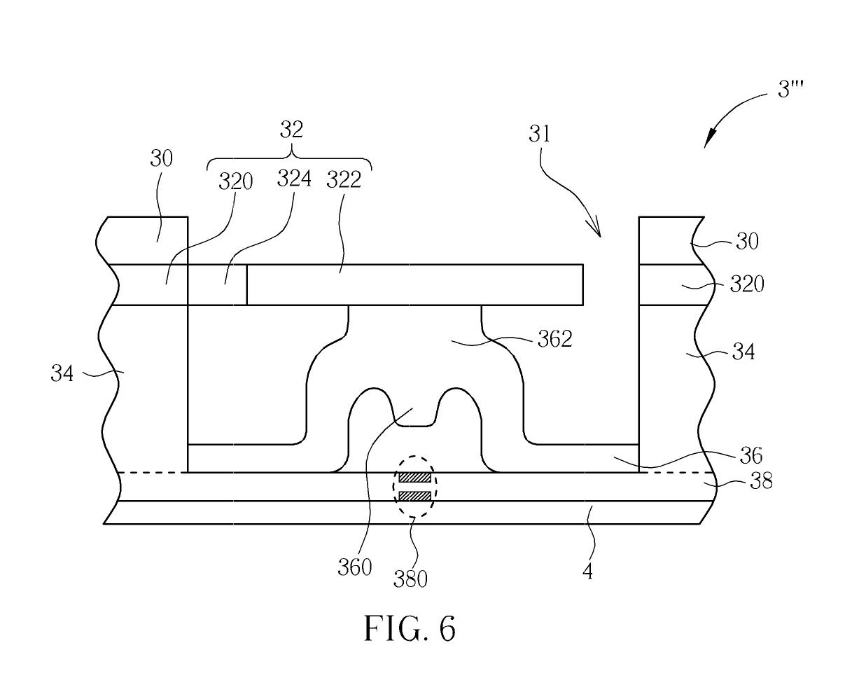

Please refer to FIG. 6, which is an illustration of the cross-sectional view of a keyswitch 3′″ according to a fourth embodiment of the invention. The keyswitch 3′″ in the embodiment incorporates the pedestal part 34 with the circuit board 38 so that these components form a monolithical one piece. The dashed lines between the circuit board 38 and the pedestal part 34 indicates the monolithical feature. Such monolithical one piece may be easily manufactured when the keycap assembly 32 and the pedestal part 34 are concurrently formed.

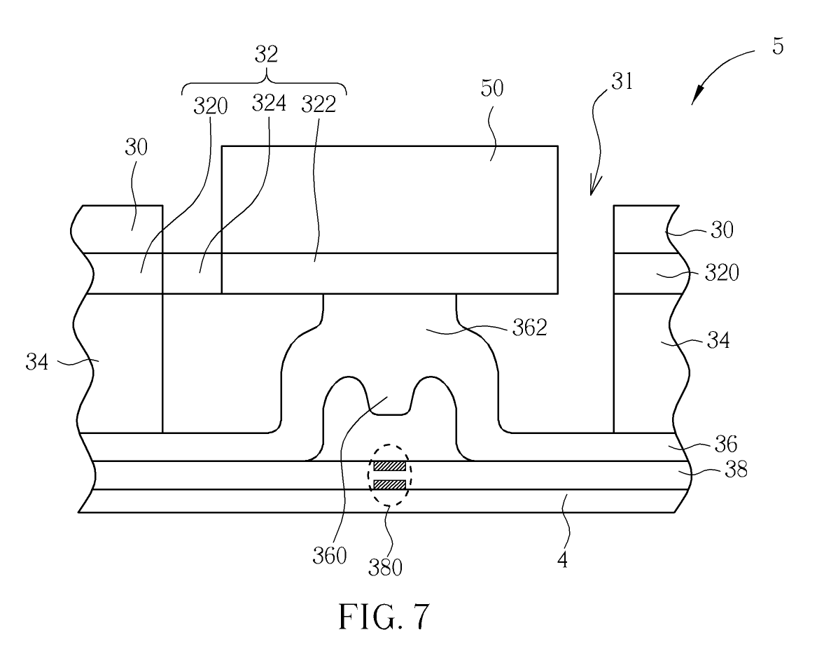

Please refer to FIG. 7, which is an illustration of the cross-sectional view of a keyswitch 5 according to a fifth embodiment of the invention. The keyswitch 5 in the embodiment includes a press section 50 on the keycap 322. As the keycap 322 is exposed from the opening 31 of the cover 30, the press section 50 further extending out from the opening 31, which provides better touch sense for the user. The press section 50 may also be implemented on any of the previous embodiments.

For the keyboard disclosed in the embodiments of the invention, the keycap assembly integrates the main body, the keycap(s), and the connecting part(s) monolithically to form a plate structure with substantially equal thickness. When the main body of the keycap assembly is constrained by the cover and the pedestal part, the keycap of the keycap assembly in the keyboard is formed as a cantilever structure via the connecting part so as to enable the keycap for moving up and down steadily, which no longer needs scissors-type structure in the keyboard. Accordingly, the keyboard may be simplified and miniaturized when utilizing such keycap assembly. Additionally, the pedestal part may be monolithically formed with the keycap assembly, the elastic piece, or the circuit board, which therefore needs no further assembly process for the pedestal part. Additionally, the press section that extends out from the cover provides better press sense for the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keyboard, comprising
a cover;
a base disposed under the cover; and
a keycap assembly disposed between the cover and the base, the keycap assembly comprising:
a main body; and
a plurality of keycaps, each keycap connecting to the main body via a connecting part, wherein the main body, the keycaps, and the connecting parts are monolithically integrated as one piece and are a plate structure with substantially equal thickness;
wherein the cover comprises a plurality of openings, each opening corresponding to one of the keycaps, and each keycap exposed from the corresponding opening when the keycap assembly is disposed between the cover and the base.

2. The keyboard of claim 1, wherein the keycap assembly further comprises a pedestal part disposed between the main body and the base.

3. The keyboard of claim 2, wherein the pedestal part, the main body, the keycaps, and the connecting parts are monolithically integrated as one piece.

4. The keyboard of claim 1, wherein the keycap assembly is formed by metal stamping.

5. The keyboard of claim 1, further comprising a plurality of elastic pieces, each elastic piece disposed correspondingly between each keycap and the base.

6. The keyboard of claim 5, further comprising a pedestal part disposed between the main body and the base.

7. The keyboard of claim 6, wherein the plurality of elastic pieces and the pedestal part are monolithically integrated as one piece.

8. The keyboard of claim 1, further comprising a circuit board disposed between the keycap assembly and the base.

9. The keyboard of claim 8, further comprising a pedestal part disposed between the main body and the base.

10. The keyboard of claim 9, wherein the circuit board and the pedestal part are monolithically integrated as one piece.

11. A keycap assembly, disposed between a cover and a base of a keyboard, the keycap assembly comprising:
a main body; and
a plurality of keycaps, each keycap connecting to the main body via a connecting part, wherein the main body, the keycaps, and the connecting parts are monolithically integrated as one piece and are a plate structure with substantially equal thickness.

12. The keycap assembly of claim 11, further comprising a pedestal part disposed between the main body and the base.

13. The keycap assembly of claim 12, wherein the pedestal part, the main body, the keycaps, and the connecting parts are monolithically integrated as one piece.

14. The keycap assembly of claim 11, wherein the keycap assembly is formed by metal stamping.
